(19) United States
(12) Patent Application Publication
(10) Pub. No.: US 2007/0018764 A1
(43) Pub. Date: Jan. 25, 2007

(54) Device and method for separating magnetic particles

(75) Inventors: Lluis Miquel Martinez Garcia, Barcelona (ES); Gustau Montero Castellana, Barcelona (ES); Sergio Garcia Soltero, Barcelona (ES)

Correspondence Address: KATTEN MUCHIN ROSENMAN LLP, 575 MADISON AVENUE, NEW YORK, NY, 10022-2585, US

(73) Assignee: ANALISI TECNOLOGICA INNOVADORA PER A PROCESSOS

(21) Appl. No.: 11/482,227

(22) Filed: Jul. 6, 2006

Related U.S. Application Data
(60) Provisional application No. 60/700,552, filed on Jul. 19, 2005.

(51) Int. Cl. H01F 1/00

(52) U.S. Cl. 335/209; 335/296; 209/223.1

(57) ABSTRACT

The invention relates to a method and device for separating magnetic particles from a sample housed in an inner space (1) of the separating device. The magnetic field of the invention is generated with a specific configuration of the magnets (3). This specific configuration permits devices of different sizes with a reduced number or types of magnets.

The present application claims priority from U.S. Provisional Application No. 60/700,552, filed Jul. 19, 2005.

The invention is included in the field of the separation of magnetic particles.

### BACKGROUND OF THE INVENTION

The separation of different types of particles has many applications. For example, in the field of medicine, biology and pharmacology, determined elements (for example, a particular type of antibody) of a sample, suspension or solution, for example, often need to be separated in order to analyze aspects regarding these elements (for example, in order to diagnose an illness). The methods traditionally used to achieve this type of separation of elements, particles or molecules are the method of separation by affinity columns and the centrifugation method.

Another method, whose use has increased in recent years, is a method of separation based on the use of magnetic particles. This method is quick and easy for precise and reliable separation of elements such as, for example, specific proteins, genetic material and biomolecules (see, for example, Z M Saiyed, et al., “Application of Magnetic Techniques in the Field of Drug Discovery and Biomedicine”, BioMagnetic Research and Technology 2003, 1:2, September 2003 [available at http.//www.biomagres.com/content/1/2]). The method is based on the use of magnetic particles designed to join to the specific elements that are to be separated from a sample, solution, suspension, etc., in some type of recipient or similar. By applying a magnetic field, the magnetic particles are separated from the rest of the sample or, rather, are concentrated in a part of the recipient, where they are retained (for example, due to the magnetic field which is applied) while the rest of the sample (or, at least, a substantial part of the rest of the sample) is removed. The retained part can subsequently be subjected to a washing process which may include another separation of magnetic particles, etc.

United States patent publ. No. US-A-4910148 and international patent application publ. No. WO-A-02/055206 disclose two systems for separation based on magnetic particles. Both systems basically use a magnet associated with the sample, in order to attract the magnetic particles so that they can be separated from the rest of the sample.

There are two types of magnetic particles. The first are those that are permanently magnetized, like a magnet. These particles are characterized in that they have a constant magnetic moment (m), which is practically independent from the external magnetic induction (B). For this family of particles, the force that is exerted on them can be expressed as:
F̅ₘ=( m̅· ∇̅) B̅

The second type of particles have a magnetization which varies according to the external magnetic field. For moderate fields, a substantially constant susceptibility can be assumed. Soft ferromagnetic, paramagnetic and superparamagnetic materials are included in this family. Using this approximation, the force that is exerted on them can be expressed as:
F̅ₘ∝χ ∇̅( B̅²)

Where χ is the magnetic susceptibility, which represents the relationship between the external magnetic field and the magnetic moment.

It emerges from these expressions that there are at least two ways of improving the effectiveness of a process for separating magnetic particles (by an increase in the forces exerted on them), namely:

by increasing the magnetic susceptibility and/or the magnetic moment; or

by generating a larger spatial variation of the magnetic field.

Increasing the magnetic susceptibility and/or the magnetic moment is no easy task without affecting other properties of the magnetic particles, closely associated with their biological functionality. However, systems, or at least theoretical ones, are already known for achieving good and effective separation, based on the use of a non-uniform magnetic field within the area of the sample.

U.S. Pat. No. 6,361,749 discloses a separator with a north-south distribution of magnets wherein the number of magnets is equal to the number of magnetic poles. However, this configuration has drawbacks since the magnetic gradient will be practically inexistent at the center of the sample when the number of poles is higher than four, which is why the particles found in the center of the recipient of the sample will not move to the walls of the recipient or will do so very slowly (and in the case of four poles generated with four magnets, although there is a gradient in the center the gradient has distortions in the area close to the magnets, as will be mentioned in more detail below).

U.S. Pat. No. 5,705,064 discloses a separator composed of a cylinder formed by a ring of magnets wherein, in a cross-section of the cylinder, each magnet has two side surfaces parallel to, and lying against, the respective side surfaces of the adjoining or adjacent magnets. The orientation of the magnetization of the magnets follows an angular progression of Δγ=2Δθ (where Δγ represents the change in angular orientation of the magnetization between one magnet and the next, and Δθ represents the change in angular position between one magnet and the next, in said cross-section of the cylinder) (in other words, an angular progression of γ=2θ, where y represents the angular orientation of the magnetization of the magnet with respect to the dipolar axis of reference and where θ is the angular position of the magnet with respect to the dipolar axis of reference, in said cross-section of the cylinder); in this way, the system produces a magnetic dipole. A relatively uniform magnetic field is thus achieved, i.e. which has a very small magnetic field gradient, something which implies a disadvantage when seeking to separate magnetic particles quickly and effectively (because, as indicated above, a large magnetic field gradient can increase the force exerted on the particles and, therefore, can increase the speed with which said particles are positioned in a desired area or areas of the sample or recipient).

United States Patent Application publications No. US-2003/0015474 discloses another separator which is also based on a cylinder formed by 8 magnets wherein, in a cross-section of the cylinder, each magnet has two side surfaces parallel to, and lying against, the respective side surfaces of the adjoining or adjacent magnets. The magnetization orientation of the magnets follows an angular progression of Δγ=3Δθ (where Δγ represents the change in angular orientation of the magnetization between one magnet and the next, and where Δθ represents the change in angular position between one magnet and the next, in said cross-section of the cylinder) (in other words, an angular progression of γ=3θ, where γ represents the angular orientation of the magnetization of the magnet with respect to the dipolar axis of reference and where θ is the angular position of the magnet with respect to the dipolar axis of reference in said cross-section of the cylinder); this system produces a magnetic quadripole.

Separators of magnetic particles based on the structure disclosed in U.S. Pat. No. 5,705,064 can generate intense magnetic fields while separators based on the structure disclosed in U.S. patent application Ser. No. 2003/0015474 can generate almost constant magnetic field gradients. These structures are based on the Halbach Theorem, which demonstrates that if the magnetization of an infinite linear magnet magnetized perpendicularly to its axis is rotated around this axis, the magnetic field is constant in module throughout the space and its direction turns in all of the space in the same angle in the direction opposite to rotation. Using this principle, dipolar sources can be developed which produce uniform fields inside cylindrical cavities (see, for example, H. A. Leupold, “Static Applications” in “Rare Earth Permanent Magnets”, J. M. D. Coey (Editor), 1996, pages 401-405). In addition, a near zero magnetic field can be achieved outside the cylinder, something which is advantageous in terms of safety. These structures are also known as “Halbach Cylinders”. The principle can be easily used on multipolar sources, achieving, in the case of four pole sources, a constant gradient.

Normally, separators of magnetic particles are used to separate magnetic particles in small volumes, typically in the order of 50 ml or less. However, the technique for separating magnetic particles can also have important applications wherein it may be useful, for technical and/or commercial purposes, to work with larger volumes (of samples, solutions, suspensions, etc.), for example, in the order of several liters. The volumes to be handled may vary substantially. It is, therefore, useful if the structure of the system that generates the magnetic field can be easily scaled.

The structures disclosed in U.S. Pat. No. 5,705,064 and U.S. Patent Application No. 2003/0015474 are based on Halbach Cylinders composed of juxtaposed magnets, so that the side surfaces of each magnet are parallel to and lying against the side surfaces of the adjoining or adjacent magnets. In the figures of both documents, it can be seen how this is achieved by using magnets whose geometric configuration, in a cross-section of the structure which generates the magnetic field of the separator, is trapezoid or substantially trapezoid, with a smaller inner side and a larger outer side, joined by both lateral sides, which correspond to the side surfaces of the magnets, which are lying against the side surfaces of the adjacent magnets. In this way, the structure generating the magnetic field has an inner surface which has a cross-section in the form of a regular polygon with shorter sides, and an outer surface which has a cross-section in the form of a regular polygon with longer sides.

Although these structures can, in theory, be good and present no major technical problems, at least not when this involves systems for separating magnetic particles in small volumes (applied to recipients of volumes in the order of a few milliliters), they can prove to have problems in terms of their scalability and in obtaining the components.

For example, if one is seeking to increase the diameter of the free space inside the cylinder, i.e. the space which receives the object (sample, suspension, solution, recipient, etc.) to be subjected to magnetic particle separation treatment and, therefore, which must be exposed to the magnetic field, the dimensions of the magnets must be modified in order to be able to maintain the design structure described above. In other words, the magnets that are used in a separator with a determined diameter of the free space inside, cannot be used in a structure with another free space inside, not, at least, if one wishes to maintain the Halbach Cylinder structure, as disclosed in U.S. Pat. No. 5,705,064 and U.S. Patent Application No. 2003/0015474. In addition, when the magnets dimensions are increased, the positioning of magnets in structures such as those disclosed in U.S. Pat. No. 5,705,064 and U.S. Patent Application No. 2003/001547 can become more and more difficult, due to an increase in the repulsion forces between the magnets.

Referring to the cross-sectional views as in FIGS. 3, 4, 7 and 9 the relationship between the geometric configuration of the magnets in the cross-section of the structure and the magnetization orientation varies between different magnets. For example, in U.S. Patent Application No. 2003/0015474, there are at least three types of relationship between magnetization and geometric configuration of the magnet:

in two of the magnets, the direction or orientation of the magnetization (S→N) goes from the larger side (outer) towards the smaller side (inner)
in two of the magnets, the direction of magnetization (S→ N) goes from the smaller side (inner) towards the larger side (outer)
in four of the magnets, the direction of magnetization (S→ N) is parallel or substantially parallel to the larger and smaller sides (in two of these, from left to right, and in the two others, in the opposite direction, seen from the outer side).

This means that in order to build a structure in accordance with, for example, U.S. Patent Application No. 2003/0015474, at least three different types of magnets must be used. Given that an element of magnetic material of the sort used for this type of magnet has a preferred or easy direction of magnetization (corresponding to the “easy axis” of the magnetic material), obtaining these three different types of magnets may require machining the original magnetic material based on three different templates. Logically, this may make obtaining the structures even more complex and costly, something which is particularly problematic in the case of producing small series of separators, and something which may be frequent when one wishes to produce separators specifically designed for the requirements of certain customers and/or applications.

### SUMMARY OF THE INVENTION

For this reason, consideration has been given to the fact that it would be desirable to base separators of magnetic particles on a structure which allows scalability and which, more specifically, allows some determined magnetic elements or magnets to be used for structures to generate magnetic fields of different dimensions.

A first aspect of the invention relates to a device for separating magnetic particles which comprises a non-uniform magnetic field generator which has a cross-section with an inner space for receiving an object to be subjected to magnetic particle separation treatment.

The generator comprises a support structure for magnets and a plurality of magnets positioned in said support structure. The magnets have, in a cross-section of the generator in a plane which comprises a plurality of said magnets, a polygonal configuration with a plurality of sides (the magnets can also have elliptical, circular configurations, etc., because, for example, a circle can be considered as a polygon with an infinite number of sides). The magnets are distributed angularly, forming at least one ring of magnets around the inner space, in order to generate a magnetic field with a number P of poles in said inner space, P being an even number greater than 2.

Each magnet has a magnetization orientation in said cross-section of the generator, the magnets of said, at least one, ring, being positioned so that the magnetization orientation of the magnets follows an angular progression of Δγ=((P/2)+1)*Δθ, where Δγ represents the change in magnetization orientation between one magnet and the next, and where Δθ represents the change in angular position between one magnet and the next, in said cross-section of the generator (and P being the aforementioned number of poles).

Said, at least one, ring comprises more than P magnets (i.e. it has a larger number of magnets than the number of poles of the magnetic field; in this way, a magnetic field with a large substantially constant magnetic gradient throughout the inner space can be achieved, given that, as is known, as the number of magnets is increased, distortions in the profile of the field are reduced in the areas closest to the field sources (for example, if only 4 magnets are used, “distortions” in the gradient are produced close to the magnets; if, however, a very high number of magnets are used, the gradient is practically perfect—i.e. there are no substantial distortions, except in areas which are already very close to the surface of the magnets).

In accordance with this aspect of the invention, there are N types of magnets in the cross-section of the generator. Each type of magnet has a determined geometric configuration and a determined relationship between its magnetization orientation and said geometric configuration, in the cross-section of the generator. In accordance with this aspect of the invention, N=1 or N=2.

This is advantageous since the use of one or, as a maximum, two types of magnets each with its own geometric configuration and magnetization/geometric configuration relationship, allows considerable flexibility with a reduced number of magnet types (1 or 2), something which is advantageous from a logistical perspective and especially important when it involves producing small series of separators. The invention enables the use of just one or two types of magnets from which separators with a wide variety of sizes and characteristics can be built. This means, for example, that the production of separators can be based on magnets obtained from a magnetic material which has been cut using one or, no more than, two different templates (taking into account the preferred direction of magnetization of the material).

The generator can be configured in such a way that, in said cross-section of the generator, the magnets do not have sides which lie against sides of magnets angularly before or after them in said ring (however, each magnet may be composed of several pieces of magnet, which may be in contact with one another and with their surfaces lying against one another). This distribution of the magnets allows great flexibility in the structure, which enables structures with different dimensions to be prepared using the same magnets, without changing the shape or dimension of the magnets as such and using magnets with simple geometric configurations. In accordance with this form of the invention, the magnets that form said ring may, for example, not be in contact with one another, or may be in contact with other magnets in the ring, but at a point of contact which only corresponds to a corner between two sides of at least one of said magnets (against a corner or side of another of the magnets).

Another aspect of the invention relates to a device for separating magnetic particles, which comprises a non-uniform magnetic field generator which has a cross-section with an inner space for receiving an object to be subjected to magnetic particle separation treatment.

The generator comprises a support structure for magnets and a plurality of magnets positioned in said support structure, said magnets having, in a cross-section of the generator in a plane which comprises a plurality of said magnets, a polygonal configuration with a plurality of sides (including the possibility of elliptical, circular configurations, etc., because, for example, a circle can be considered as a polygon with an infinite number of sides, etc.).

The magnets are distributed angularly, forming at least one ring of magnets around the inner space, in order to generate a magnetic field with a number P of poles in said inner space, P being an even number greater than 2.

Each magnet has a magnetization orientation in said cross-section of the generator, the magnets of said, at least one, ring being positioned so that the orientation or direction of magnetization of the magnets follows an angular progression of Δγ=((P/2)+1)*Δθ, where Δγ represents the change in magnetization orientation between one magnet and the next, and where Δθ represents the change in angular position between one magnet and the next, in said cross-section of the generator, and said, at least one, ring having more than P magnets (i.e., it has a larger number of magnets than the number of poles of the magnetic field generated. In this way, a magnetic field with a large substantially constant magnetic gradient throughout the inner space can be achieved, given that, as is known, as the number of magnets is increased, distortions in the profile of the field are reduced in the areas closest to the field sources. For example, with only 4 magnets, the magnetic gradient close to the magnets has considerable “distortions”, while, if a high number of magnets are used, the magnetic gradient does not have such substantial distortions, except in an area which is already very close to the surface of the magnets).

In accordance with this aspect of the invention, the generator is configured so that, in said cross-section of the generator, the magnets do not have sides which lie against sides of magnets angularly before or after them in said ring (although each magnet may be composed of several pieces of magnet which may be positioned with their surfaces lying against one another).

This configuration allows great flexibility at the time of designing magnet structures, which enables structures with different dimensions to be prepared using a single type of magnet (or, at least, a reduced number of magnets). Given that the magnets are not in contact with one another or, at least, their surfaces are not lying against one another, many different magnet configurations can be achieved without having to change the shape or dimension of the magnets as such, or the magnetization orientation with respect to the geometric configuration of the magnets.

The magnets that form the ring may, for example, not be in contact with one another, or if there is some contact between two successively angular magnets in said ring, said contact may just correspond to a corner between two sides of at least one of said magnets (against a corner or side of another of the magnets).

In said cross-section of the generator, there may be, for example, N types of magnets, each type of magnet having a determined geometric configuration and a determined relationship between their magnetization orientation and said geometric configuration, in the cross-section of the generator, being N=1 or N=2. The use of one or, as a maximum, two types of magnets each with its geometric configuration and magnetization/geometric configuration relationship, allows considerable flexibility with a reduced number of types of magnets something which is advantageous from a logistical point of view and especially important when it involves producing short series of products for specific purposes. The invention allows just one or two types of magnets to be used, from which separators of very diverse sizes and characteristics can be built, which enables all the magnets to be obtained from magnetic material which is cut based on one or two templates.

Either of the two aspects of the invention described above can be carried out in accordance with many forms. For example, in the cross-section, the magnets may have a rectangular or hexagonal polygonal configuration, or substantially rectangular or hexagonal configuration.

Another aspect of the invention relates to a device for separating magnetic particles, which comprises a non-uniform magnetic field generator which has a cross-section with an inner space for receiving an object to be subjected to magnetic particle separation treatment, said generator comprising a support structure for magnets and a plurality of magnets positioned in said support structure. The magnets have, in a cross-section of the generator in a plane which comprises a plurality of said magnets, a polygonal configuration with a plurality of sides. The magnets are distributed angularly, forming at least one ring of magnets around the inner space, in order to generate a magnetic field with a number P of poles in said inner space, P being an even number greater than 2.

In accordance with this aspect of the invention, the polygonal configuration is a hexagonal configuration. The hexagonal configuration may be very advantageous since it allows easily scalable structures to be established using few types of relationships between the magnetization orientation and the geometric configuration of the magnets, with the advantages this implies (see explanation above). The structures may be easily scalable by, for example, removing one ring of magnets. These scalable structures of magnets or with an inner space that can be easily increased can also be built with the magnets in contact with one another, with the sides of the magnets lying against the sides of adjacent magnets in the form of a honeycomb or similar.

Each magnet can have a magnetization orientation in said cross-section of the generator, and the magnets of said, at least one, ring can be positioned so that the magnetization orientation of the magnets follows an angular progression of Δγ((P/2)+1)*Δθ, where Δγ represents the change in magnetization orientation between one magnet and the next, and where Δθ represents the change in angular position between one magnet and the next, in said cross-section of the generator.

Said, at least one, ring can comprise more than P magnets (i.e. the number of magnets can be greater than the number of poles in the magnetic field). In this way, a magnetic field with a constant magnetic gradient can be achieved throughout the inner space, especially when P=4 (with P>4 the gradient is not constant, e.g. with P=6 the gradient rises linearly, it being zero in the center which implies less effectiveness in separation). Using a larger number of magnets than the number of poles in the magnetic field allows a magnetic field to be obtained with a large substantially constant magnetic gradient throughout the inner space, given that, as is known, as the number of magnets is increased, distortions in the profile of the field are reduced in the areas closest to the field sources. For example, if only 4 magnets are used, “distortions” in the gradient are produced close to the magnets. If, however, a very high number of magnets are used, the gradient is practically perfect—i.e. there are no substantial distortions, except in areas which are already very close to the surface of the magnets.

In the cross-section of the generator, there may be N types of magnets, each type of magnet having a determined geometric configuration and a determined relationship between their magnetization orientation and geometric configuration, in the cross-section of the generator, N possibly being, for example, 1 or 2. The use of one or, as a maximum, two types of magnet:, each with its geometric configuration and magnetization/geometric configuration relationship, allows considerable flexibility with a reduced number of magnet types, something which is very good from a logistical perspective and especially important when it involves producing small series. The invention allows just one or two types of magnets to be used, from which separators of very diverse sizes and characteristics can be built.

The generator can be configured so that, in the cross-section of the generator, the magnets do not have sides which lie against sides of magnets angularly before or after them in the ring (although each magnet may be composed of several pieces of magnet, whose surfaces lie against one another). This allows great flexibility in the structure, which enables structures with different dimensions to be prepared using the same magnets or types of magnet, without changing the shape or dimension of the magnets as such. In accordance with this form of the invention, there is the option of arranging the magnets such that the magnets forming the ring are not in contact with one another, or such that some or all of the magnets are in contact, but only in such a way that the contact between two successively angular magnets in the ring corresponds to one corner between two sides of at least one of the magnets, against a corner or side of another of the magnets.

Any of the aspects of the invention described above can be configured in accordance with various forms, which may include some or all of the following optional characteristics:

In the cross-section, the magnets that compose the ring of magnets may have an orientation of their geometric configuration which follows an angular progression of Δγ=((P/2)+1)*Δθ, where Δγ represents the change in angular orientation of the geometric configuration between one magnet and the next, and where Δθ represents the change in angular position between one magnet and the next, in said cross-section of the separator. In other words, the distribution of the magnets may be such that the angular orientation of the geometric configuration of the magnets is modified, rather than modifying the magnetization with respect to said geometric configuration. This is advantageous since it allows the original magnetic material to be cut using a single template, i.e. producing pieces, all of which have the same relationship between magnetization and geometric configuration.

The number of poles (P) may be 4, which allows a large constant gradient in the magnetic field to be obtained, throughout the inner space.

The magnets may have, in the cross-section of the generator in the plane which comprises a plurality of the magnets, an equilateral polygonal configuration.

The magnets may be parallelepipeds.

In the cross-section, the magnets may be distributed in a configuration which comprises a plurality of concentric rings of magnets.

The structure may comprise a plurality of rings of magnets distributed along a longitudinal axis of the device, perpendicular or substantially perpendicular to the cross-section.

One or more of the magnets may be composed of at least two pieces of juxtaposed magnet.

The support structure may comprise a plurality of support elements (for example, in the form of aluminum rings) positioned one after the other along a longitudinal axis of the device, each support element having a plurality of holes with a geometric configuration matching the geometric configuration of the magnets, for receiving the magnets.

The magnets may, for example, be made of NdFeB, SmCo, Ni, or, more generally, may be magnets with magnetic anisotropy, for example, with magnetocrystalline anisotropy (without this characteristic, there is a risk of the magnets demagnetizing due to the magnetic fields generated by their neighbors, which could happen, for example, if the material were steel or AlNiCo).

Another aspect of the invention relates to a method for separating magnetic particles in an object (for example, a container which contains a fluid, for example, a liquid with magnetic particles in suspension). In accordance with this aspect of the invention, the method comprises the step of placing the object in the inner space of a device in accordance with any of the methods described above.

### BRIEF DESCRIPTION OF THE DRAWINGS

FIG. 1 shows a diagrammatic perspective view of a support structure of a separator.

FIG. 2 shows a cross-sectional view of a separator.

FIG. 3 shows a diagrammatic view of the orientation of the magnets and their direction of magnetization in side sections of separators in one embodiment of the invention.

FIG. 4 shows a diagrammatic view of the orientation of the magnets and their direction of magnetization in side sections of separators in another embodiment of the invention.

FIG. 5 shows a perspective view of a support structure in two assembly phases, in accordance with an embodiment of the invention.

FIG. 6 shows another perspective view of a support structure in two assembly phases, in accordance with an embodiment of the invention.

FIG. 7 diagrammatically shows the configuration of the structure of magnets in a cross-section view of the separator, in one embodiment based on hexagonal magnets.

FIG. 8 shows a cross-sectional view of a separator.

FIG. 9 shows a diagrammatic view of the orientation of the magnets and their direction of magnetization in side sections of separators in one embodiment of the invention.

FIG. 10. Shows a perspective view of a complete separator.

### DETAILED DESCRIPTION OF THE INVENTION

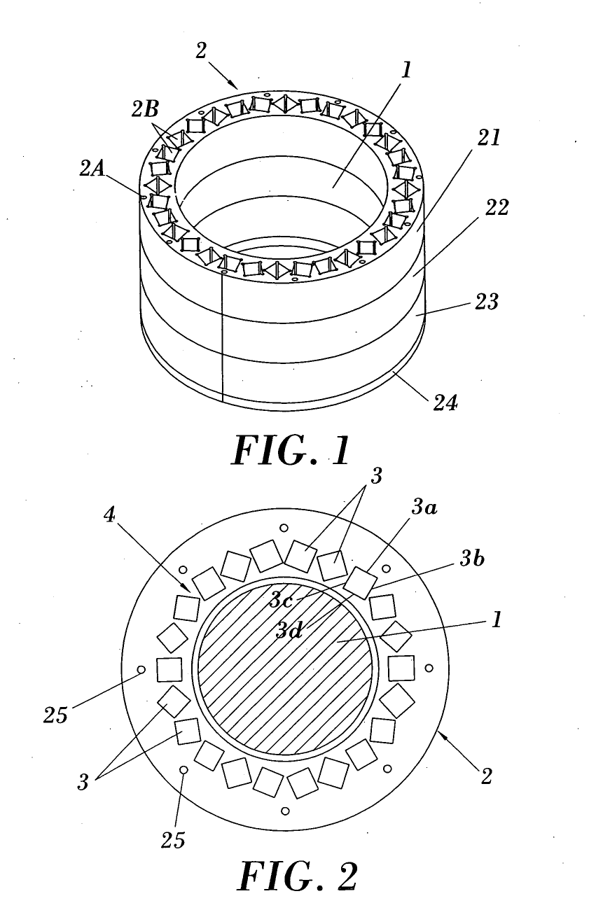

FIG. 1 diagrammatically reflects a possible preferred embodiment of the invention and, more specifically, the support structure 2 which comprises a plurality of support rings, for example, of aluminum, diagrammatically illustrated as rings 21, 22, 23, placed on top of a support or base 24. The free space 1 within the rings is the one which receives the sample or object which is to be subjected to magnetic particle separation treatment.

As can be seen in ring 21 (which has a configuration identical or substantially identical to that of the other rings 22 and 23), the support rings have a series of holes or channels 2B, wherein the magnets are housed, so that the magnets remain immobilized, in spite of the forces of attraction or repulsion which are exerted between them. The illustrated structure can also be completed with a cover (not illustrated) which prevents the vertical movement of the magnets (i.e. a movement parallel to the longitudinal axis of the support structure). Holes 2A can also be seen in FIG. I wherein some bars will be positioned, which can be made of brass or stainless steel and which are used to keep the rings joined. Basically, said bars, together with the aluminum rings 21, 22, 23, the base 24 and the cover (not illustrated) form the support structure.

The magnets are positioned in the channels or holes 2B. Each magnet can be composed of two or more pieces of magnet, which are juxtaposed in order to form a magnet, whose cross-section corresponds to the cross-section of the hole or channel 2B, so that the magnet remains in said hole, with no play or with quite a limited amount of play.

FIG. 2 diagrammatically shows how, in a support structure 2 of the type illustrated in FIG. 1, fixed using a plurality of bars 25 of brass or similar which pass through the support rings of the structure, a plurality of magnets 3 are housed in the holes 2B, each magnet having a plurality of sides. Specifically, FIG. 2 reflects a cross-section of the separator, and it can be seen how the magnets 3, in said cross-section, have a polygonal cross-section, specifically in the form of a rectangle or, more specifically, in the form of a square. The magnets are not in contact with one another. In particular, no side or surface 3a, 3b, 3c and 3d of a magnet lies against a surface or side of an adjacent magnet (although the possibility of letting a corner of a magnet touch a corner or side of an adjacent magnet could be envisaged, without it going beyond the scope of the invention). As can be understood in FIG. 2, the magnets 3 are positioned to form a ring of magnets 4, and the fact that the magnets do not have to lie with their sides against one another means that the variation in the direction of magnetization between one magnet and the next, around the ring 4, can be established by adapting the relationship between the physical part which composes the magnet and the support structure, without needing to use pieces of magnet which have different relationships between the direction of their magnetization (in the cross-section of the separator) and their geometric configuration.

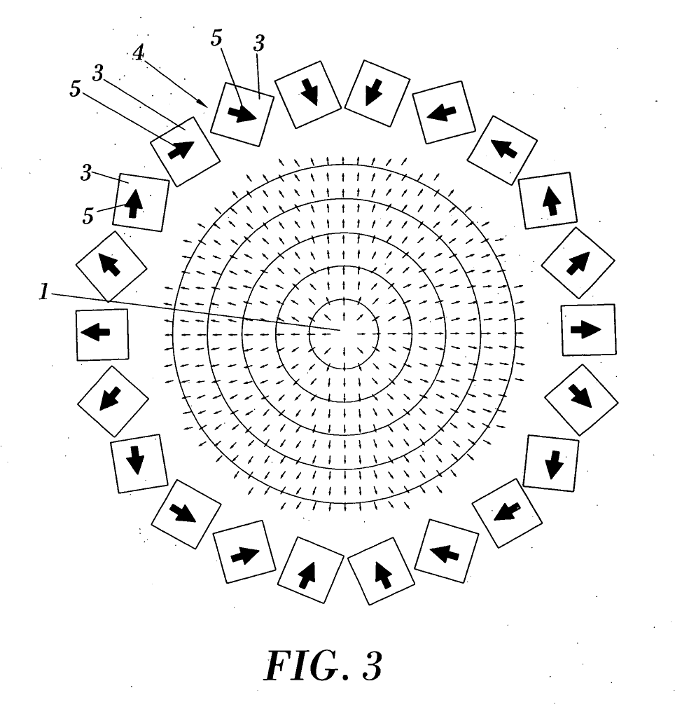

This concept can be understood more easily by looking at FIG. 3, which illustrates the distribution of the magnets 3 in a cross-section of the separator, in a possible embodiment of the invention. As can be seen, the arrow which indicates the direction or magnetization orientation 5 has, for all the magnets, the same relationship with respect to the geometric configuration of the magnet in the plane of the cross-section of the separator.

Specifically, all the magnets have a magnetization orientation parallel to two of their sides and perpendicular to the other two sides. This means that all the magnets can be obtained by cutting a piece of magnetic material based on the same template, in directions parallel and perpendicular to the direction of easy magnetization of said material (i.e. the direction corresponding to the so-called “easy axis” of the material).

As shown in FIG. 3, which reflects a distribution of magnets which generates a magnetic field with four poles in the inner space of the separator, the magnetization orientation 5 of the magnets 3 of the ring of magnets 4 follows an angular progression of γ=3*Δθ, where Δγ represents the change in magnetization orientation 5 between one magnet 3 and the next, and where Δθ represents the change in angular position between one magnet 3 and the next, in said cross-section of the generator. However, in accordance with the invention, this is achieved not by modifying the relationship between the magnetization orientation of the magnets with respect to the geometric configuration of the magnets, but by modifying the orientation of the geometric configuration of the magnets with respect to the support structure; specifically, as can be seen in FIG. 3, the magnets 3 which form the ring of magnets 4 have an orientation of their geometric configuration which follows an angular progression of Δγ=3Δθ, where Δγ represents the change in the angular orientation of the geometric configuration between one magnet 3 and the next, and where Δθ represents the change in angular position between one magnet and the next, in said cross-section of the separator. In other words, since the sides of the magnets do not have to lie against the sides of the adjacent magnets, the angular progression of the magnetization orientation can be created via a corresponding angular progression of the orientation of the physical elements which compose the magnets.

In a configuration like the one illustrated in FIG. 3, the induction module of the magnetic field (B) which is generated increases radically; it changes from a zero induction at the center of the ring 4 (i.e. at the center of the inner free space 1) to a high induction on the edge (close to the ring of magnets), with a substantially constant gradient, which may, in a typical case, be of several T/m. This constant gradient causes magnetic particles present in a sample which is introduced in the inner space, for example, in a container which occupies the majority of said inner space, at least in a cross-section of the separator, to move towards the walls of the container. In FIG. 3, the arrows in the “inner space” 1 outlined by the ring 4 illustrate the direction of the magnetic gradient and, therefore, the direction of the force which is exerted on the magnetic particles in a sample and which makes them move towards the walls of the container which contains the sample. The approximately circular lines in FIG. 3 represent equipotential lines, i.e. lines formed by the points at which the intensity of the magnetic field has the same value (this also applies to the other figures which show this type of lines and arrows).

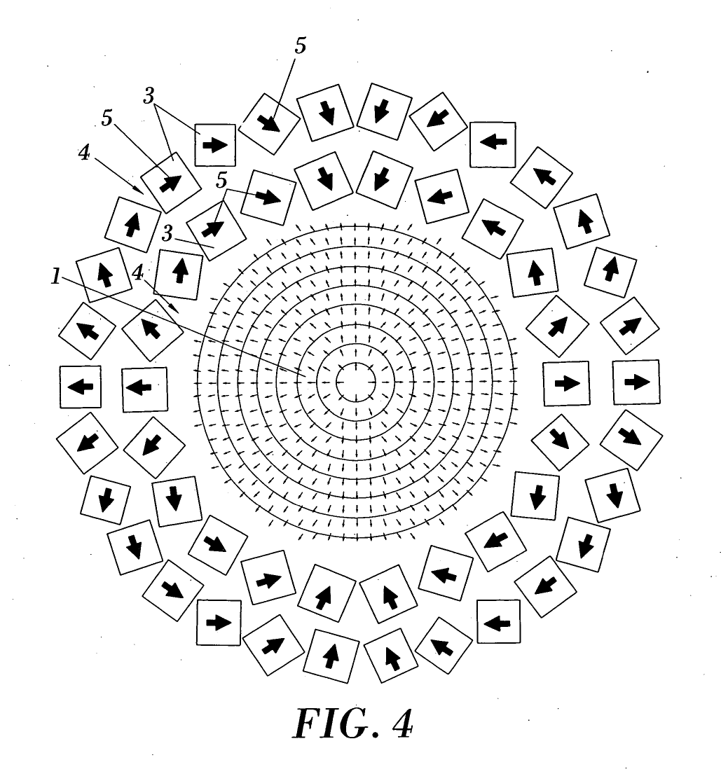

FIG. 4 shows a distribution of magnets according to another possible embodiment of the invention. In this case, the magnets 3 are distributed in two rings; the angular progression of orientation of their magnetization 5 is the same as in the configuration illustrated in FIG. 3, but in this case, using two rings of magnets, one with 22 magnets and the other, outer one, with 30 magnets, using the same type of magnets as in the configuration in FIG. 3, a greater gradient of the magnetic field is achieved.

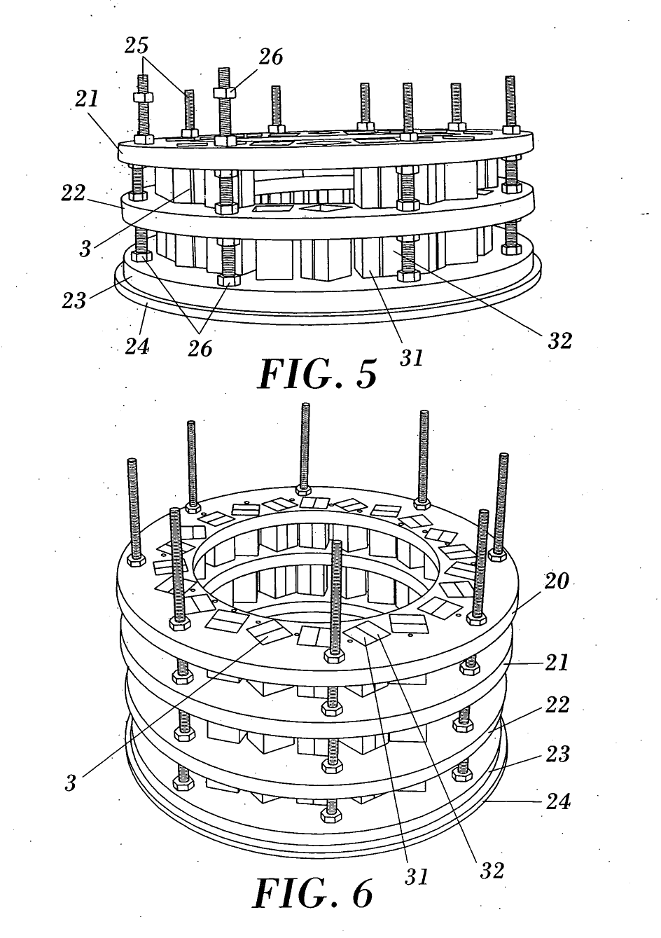

FIG. 5 illustrates a support structure under assembly, in accordance with a possible preferred embodiment of the invention. Specifically, it can be seen how three rings 21, 22, 23 of, for example, aluminum and with a height of approximately 10 mm have been fixed to a base plate 24. The rings can be made from aluminum plates of, for example, 10 mm thick and cut by laser.

The rings are fixed to one another by a fixing system which comprises bars 25 of, for example, brass or non-magnetic stainless steel. The bars 25 are threaded and the aluminum rings are fixed at the desired height using bolts 26 of, for example, plastic. It has been illustrated diagrammatically how each magnet 3 is composed of two parts 31, 32 which together constitute the magnet 3.

FIG. 6 shows another assembly phase for the separator, wherein another aluminum ring 20 has been added and wherein all the magnets 3 have been incorporated, each one composed of two parts 31 and 32. The structure illustrated in FIG. 6 has three layers of magnets. The magnets can, for example, be NdFeB magnets or of any other suitable material, depending on the specific characteristics that one is seeking to obtain.

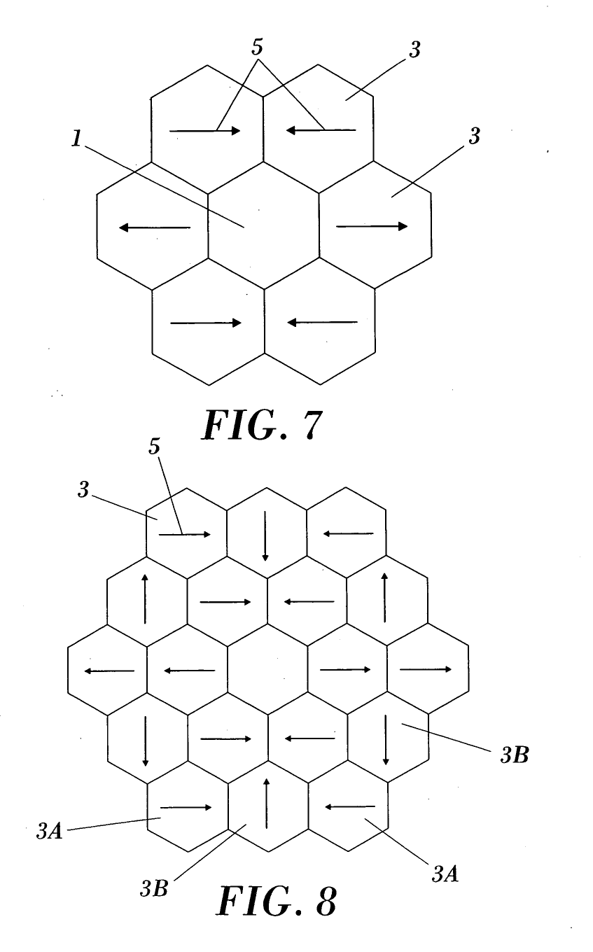

FIG. 7 diagrammatically illustrates another possible embodiment of the invention, wherein magnets 3 are used with a hexagonal cross-section, positioned in a ring around the inner space 1 which will receive the sample or object to be treated. With this configuration, using magnets with a hexagonal cross-section, a suitable angular progression of the magnetization orientation 5 can be achieved, with a single relationship between the magnetization orientation and the geometric configuration of the cross-section of the magnets, while the magnets can be placed side to side (i.e. with two sides of the same magnet lying against respective sides of adjacent magnets), with the advantages that this implies from a structural perspective.

FIG. 8 illustrates another configuration based on two rings of hexagonal magnets, an inner one and an outer one, all the magnets having the side surfaces resting against the side surfaces of adjacent magnets, of the same and the other ring. In this case, all the magnets have the same geometric configuration, but there are two types of relationship between magnetization and geometric configuration: as can be seen, some magnets 3A have a magnetization orientation 5 which is perpendicular to the two surfaces of the magnet, and other magnets 3B have an orientation which moves towards the edge between two surfaces.

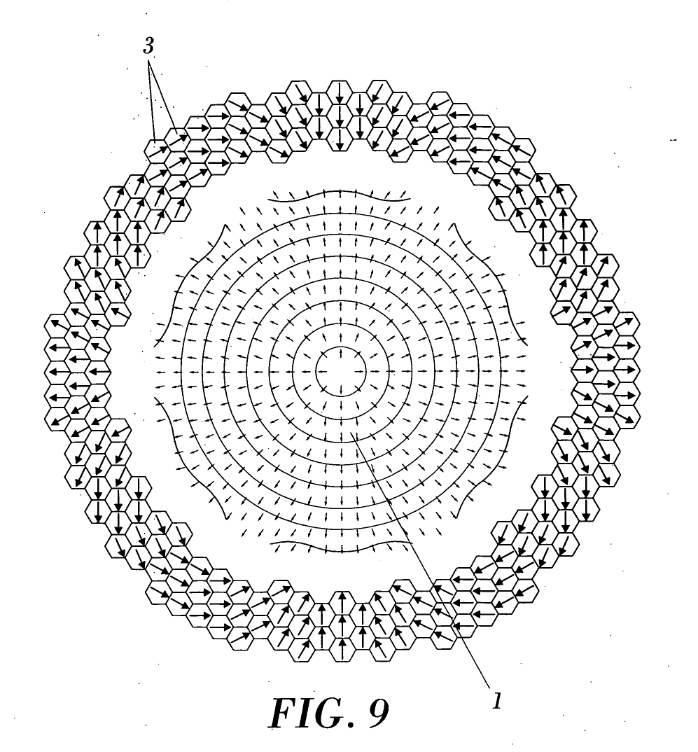

FIG. 9 illustrates another configuration based on magnets with a hexagonal cross-section; the inner space 1 illustrates the direction of the magnetic gradient (with arrows) and some equipotential lines, i.e. lines formed at the points at which the intensity of the cross-section of the magnetic field has the same value.

As can be easily seen in these figures, the configuration “in the form of a honeycomb”, with various “rings” of magnets with a hexagonal configuration, has important advantages, since it allows easily scalable systems to be designed. For example, in order to increase the diameter of the inner space 1 of a separator with the configuration illustrated in FIG. 8, the magnets 6 in the inner ring, etc. could easily be eliminated.

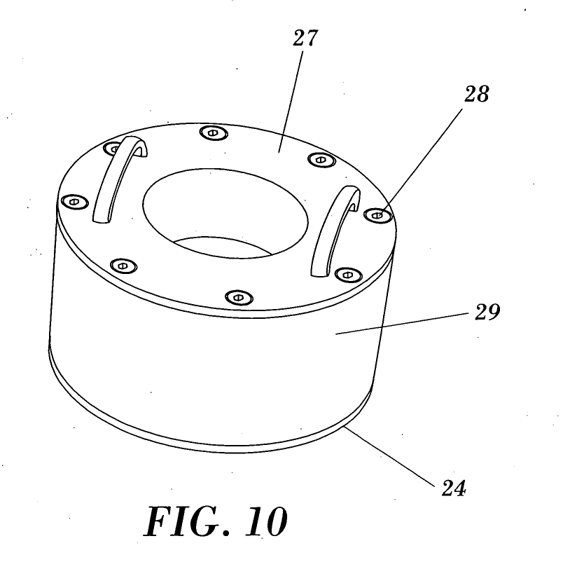

In FIG. 10, a complete separator can be seen, based on the design illustrated in FIGS. 5 and 6, but with an outer covering 29 and a cover 27. The cover is fixed to the bars 25 (not illustrated in FIG. 10) with screws 28.

In this text, the word “comprises” and variations thereof (such as “comprising”, etc.) should not be taken as being exclusive, that is, they do not exclude the possibility that the item described might include other elements, steps, etc.

Furthermore, the invention is not limited to the specific embodiments described above, but also covers, for example, variations that might be made by the person skilled in the art (for example, as regards the choice of materials, dimensions, components, configuration, etc.), within the bounds of what can be inferred from the claims.

1. A device for separating magnetic particles comprising:
a non-uniform magnetic field generator with a cross-section having an inner space (1) for receiving an object to be subjected to magnetic particle separation treatment;
said generator comprising a support structure (2) for magnets with a plurality of magnets (3) positioned in said support structure;
said magnets (3) having, in a cross-section of the generator in a plane which comprises a plurality of said magnets, a polygonal configuration with a plurality of sides;
the magnets (3) distributed angularly, forming at least one ring (4) of magnets around the inner space, to generate a magnetic field having a number P of poles in said inner space (1), where P is an even number greater than 2;
each magnet (3) having a magnetization orientation (5) in said cross-section of the generator, the magnets (3) of said at least one ring (4) being positioned so that the magnetization orientation (5) of the magnets follows an angular progression of Δγ=((P/2)+1)*Δθ, where Δγ represents the change in magnetization orientation (5) between one magnet and the next, and where Δθ represents the change in angular position between one magnet and the next, in said cross-section of the generator, and said, at least one, ring comprising more than P magnets;
wherein
in said cross-section of the generator, there are N types of magnets, each having a determined geometric configuration and a determined relationship between magnetization orientation and said geometric configuration, in the cross-section of the generator, N=1 or N=2.

2. The device according to claim 1 wherein in the cross-section of the generator, the magnets (3a, 3b, 3c, 3d) do not have sides which lie against the sides of magnets angularly before or after them in said ring.

3. The device according to claim 2, wherein the magnets (3) which form the ring are not in contact with one another.

4. The device according to claim 2, wherein if there is a contact between two angularly successive magnets (3) in said ring, said contact corresponds to only one corner between two sides of at least one of said magnets.

5. The device according to claim 1, wherein in said cross-section, the magnets have a rectangular polygonal configuration.

6. The device according to claim 1, wherein in said cross-section, the magnets have a hexagonal polygonal configuration.

7. A device for separating magnetic particles comprising:
a non-uniform magnetic field generator having a cross-section with an inner space (1) for receiving an object to be subjected to magnetic particle separation treatment;
said generator having a support structure (2) for magnets and a plurality of magnets (3) positioned in said support structure;
said magnets (3) having, in a cross-section of the generator in a plane which comprises a plurality of said magnets, a polygonal configuration with a plurality of sides;
the magnets (3) distributed angularly, forming at least one ring (4) of magnets around the inner space, to generate a magnetic field having a number P of poles in said inner space (1), where P is an even number greater than 2;
each magnet (3) having a magnetization orientation (5) in said cross-section of the generator, the magnets (3) of said, at least one ring (4) being positioned so that the magnetization orientation (5) of the magnets follows an angular progression of Δγ=((P/2+1)*Δθ, where Δγ represents the change in magnetization orientation (5) between one magnet and the next, and where Δθ represents the change in angular position between one magnet and the next, in said cross-section of the generator, and said, at least one, ring comprising more than P magnets;
wherein
the generator is configured so that, in said cross-section of the generator, the magnets do not have sides (3a, 3b, 3c, 3d) which lie against the sides of magnets angularly before or after them in said ring.

8. The device according to claim 7, wherein the magnets (3) which form said ring are not in contact with one another.

9. The device according to claim 7, wherein if there is a contact between two angularly successive magnets (3) in said ring, said contact corresponds only to one corner between two sides of at least one of said magnets.

10. The device according to claim 7, wherein in said cross-section of the generator, there are N types of magnets, each type of magnet having a determined geometric configuration and a determined relationship between their magnetization orientation and said geometric configuration, in the cross-section of the generator, N=1 or N=2.

11. The device according to claim 1, wherein in said cross-section, the magnets have a rectangular polygonal configuration.

12. The device according to claim 1, wherein in said cross-section, the magnets have a hexagonal polygonal configuration.

13. A device for separating magnetic particles comprising:
a non-uniform magnetic field generator having a cross-section with an inner space (1) for receiving an object to be subjected to magnetic particle separation treatment;
said generator having a support structure (2) for magnets and a plurality of magnets (3) positioned in said support structure;
said magnets (3) having, in a cross-section of the generator in a plane which comprises a plurality of said magnets, a polygonal configuration with a plurality of sides;
the magnets (3) distributed angularly, forming at least one ring (4) of magnets around the inner space, to generate a magnetic field having a number P of poles in said inner space (1), where P is an even number greater than 2; and
wherein said polygonal configuration is a hexagonal configuration.

14. The device according to claim 13, wherein each magnet (3) has a magnetization orientation (5) in said cross-section of the generator, and the magnets (3) of said at least one ring (4), being positioned so that the magnetization orientation (5) of the magnets follows an angular progression of Δγ=((P/2)+1)*Δθ, where Δγ represents the change in magnetization orientation (5) between one magnet and the next, and where Δθ represents the change in angular position between one magnet and the next, in said cross-section of the generator.

15. The device according to claim 13, wherein said at least one ring (4) comprises more than P magnets.

16. The device according to claim 13, wherein said cross-section of the generator comprises N types of magnet, each having a determined geometric configuration and a determined relationship between magnetization orientation and geometric configuration, in the cross-section of the generator and where N=1 or N=2.

17. The device according to claim 13, wherein in the said cross-section of the generator, the magnets do not have sides (3a, 3b, 3c, 3d) which lie against the sides of magnets angularly before or after them in said ring.

18. The device according to claim 17, wherein the magnets (3) which form the ring are not in contact with one another.

19. The device according to claim 17, wherein if there is a contact between two angularly successive magnets (3) in said ring, said contact corresponds to only one corner between two sides of at least one of said magnets.

20. The device according to claim 13, in which in said cross-section, the magnets (3) composing the ring of magnets have an orientation of their geometric configuration following an angular progression of Δγ=((P/2)+1)*Δθ, where Δγ represents the change in angular orientation of the geometric configuration between one magnet and the next, and where Δθ represents the change in angular position between one magnet and the next, in said cross-section of the separator.

21. The device according to claim 1, in which the number of poles P=4.

22. The device according to claim 7, in which the number of poles P=4.

23. The device according to claim 1, in which the magnets (3) have, in said cross-section of the generator, in said plane comprising a plurality of said magnets, an equilateral polygonal configuration.

24. The device according to claim 7, in which the magnets (3) have, in said cross-section of the generator, in said plane comprising a plurality of said magnets, an equilateral polygonal configuration.

25. The device according to claim 1, in which the magnets are parallelepipeds.

26. The device according to claim 7, in which the magnets are parallelepipeds.

27. The device according to claim 1, in which in said cross-section, the magnets are distributed in a configuration comprising a plurality of concentric rings of magnets.

28. The device according to claim 7, in which in said cross-section, the magnets are distributed in a configuration comprising a plurality of concentric rings of magnets.

29. The device according to claim 1, in which the structure comprises a plurality of rings of magnets distributed along a longitudinal axis of the device, perpendicular to said cross-section.

30. The device according to claim 7, in which the structure comprises a plurality of rings of magnets distributed along a longitudinal axis of the device, perpendicular to said cross-section.

31. The device according to claim l, in which at least one of the magnets comprises at least two juxtaposed pieces of magnet.

32. The device according to claim 7, in which at least one of the magnets comprises at least two juxtaposed pieces of magnet.

33. The device according to claim 1, in which the support structure (2) comprises a plurality of support elements (21, 22, 23) positioned one after the other along a longitudinal axis of the device, each support element having a plurality of holes (2B) with a geometric configuration matching the geometric configuration of the magnets (3), for receiving the magnets.

34. The device according to claim 7, in which the support structure (2) comprises a plurality of support elements (21, 22, 23) positioned one after the other along a longitudinal axis of the device, each support element having a plurality of holes (2B) with a geometric configuration matching the geometric configuration of the magnets (3), for receiving the magnets.

35. A method for separating magnetic particles in an object, comprising positioning the object in the inner space of a device as in claim 1.

36. A method for separating magnetic particles in an object, comprising positioning the object in the inner space of a device as in claim 7.
